(19) United States
(12) Patent Application Publication
(10) Pub. No.: US 2011/0215121 A1
(43) Pub. Date: Sep. 8, 2011

(54) Drink-tray holder keeps a drink-tray level and secure on the passenger seat of your car

(76) Inventor: Kevin Michael Hutchison, Liberty, MO (US)

(21) Appl. No.: 12/931,963

(22) Filed: Feb. 15, 2011

Related U.S. Application Data
(60) Provisional application No. 61/311,200, filed on Mar. 5, 2010.

(51) Int. Cl. B60R 7/04

(52) U.S. Cl. 224/275

(57) ABSTRACT

When you set a drink-tray on your seat you are running the risk of one of the lids popping off and your drink spilling onto your seat. Also, most seats are slanted, not level, which allows some of the drinks to leak out of the lid onto your seat and seatback. The drink-tray holder provides a sturdy base for the drink-tray to set upon in your vehicle's seat. It also has several reservoirs to catch any spills that may occur.

### CROSS-REFERENCE TO RELATED APPLICATION

This application relates to provisional application U.S. Ser. No. 61/311,200 claiming benefit of the j earlier filing date of Mar. 5, 2010.

### DESCRIPTION

The present invention relates to a drink-tray holder, keeps a drink-tray level and secure on the passenger seat of your car.

The device is comprised of the following:
Reference Letter Name of Part
A Platform
B Back Side
C Front Side
D Left Side
E Sides of Platform
F Back Side of Platform
G Base

The Drink-Tray Holder is a device configured and designed to support a drink-tray, from a fast-food restaurant, level and collect any liquid that may spill from the drink lid coming off.

The Drink-Tray Holder (DTH) would be placed on a vehicles seat. All measurements are approximate and can be made larger or smaller. The bottom of the DTH is shaped to the contour of a car seat, angled from front to back. It is shaped like a square with 4 sides, 1 front side “C”, 2 sides “D” (Left & Right), and 1 back side “B”. The sides “D” are narrow or short near the front side “C” and wide or tall near the back side “B”. On the bottom edge of the left & right sides “D”, approximately ¾ of an inch from the front “C” and 1 inch from the back “B” is parallel to the top edge, the rest of the bottom edge is angled down from front “C” to back “B”. The side “D” is approximately 8½ inches wide and approximately 1 inch tall at the front “C” and approximately 3 inches tall at the back “B”. The back side “B” is rectangular in shape, approximately 3 inches tall and 8½ inches wide. The front side “C” is rectangular in shape, approximately 1 inch tall and 8½ inches wide. Approximately 1 inch down from the top edge is where 2 platforms “A” extend across the DTH from the front side “C” to the back side “B”. The platforms “A” are approximately 2½ inches wide and 6¾ inches long. The platforms “A” are approximately 1 inch from the left & right sides “C” and are approximately 1½ inches apart . The platforms “A” are parallel to the top edge of all 4 sides. Each platform “A” has 2 sides “E” shaped like triangles.

The edge of side “E” that touches the platform “A” is approximately 6¾ inches long, the edge of side “E” that touches the base “G” is approximately 6⅞ inches long, the back edge of side “E” that touches the back side of platform “F” is approximately 2 inches tall. Each platform “A” has a back side “F” that is approximately 2½ inches wide and 2 inches tall. There is a base “G” which touches the bottom edge of all sides, “B”, “C”, “D”, “E” and “F”.

The front side “C” is connected to both left side “D” and right side “D” and the base “G”. Both left side “D” and right side “D” are connected to the front side “C”, the back side “B”, and the base “G”. The back side “B” is connected to the left side “D” and right side “D” and the base “G”. The base “G” is connected to the front side “C”, the left side “D”, the right side “D”, the back side “B”, and all 4 platform sides “E”, and the platform back side “F”. The platforms “A” are connected to both platform back sides “F”, all 4 platform sides “E”, and the base “G” near the front side C”.

The base is made up of 5 separate pieces. The base that touches the bottom edge of the front side “C” is 8½ inches and ¾ of an inch wide and touches the bottom edge of left side “D” and right side “D”. The base between both platforms “A” are 1½ inches wide and 6⅞ inches long, from the front side to the back side. The base “G” that touches the bottom edge of the left side “D” and right side “D” is 1 inch wide and 6⅞ inches long and there are 2 of them. The base “G” that touches the back side “B” is 8½ inches wide and 1 inch deep.

The space between both platforms “A” and the left side “D” and the right side “D” and the back side “B” is open and would collect any liquid that may spill from a drink in the drink-tray. All of the edges and corners could either be squared or rounded.

The left side “C” and right side “C” can be interchanged. All 4 platform sides “E” can be interchanged. The platforms “A” can be interchanged with each other. The platform backs “F” can be interchanged with each other.

All of the pieces of the DTH are necessary to function properly. No elements are optional. A bar or block could be added under the front of the DTH, for vehicles whose seat has little or no angle from front to back.

The invention provides a level and secure place to set a drink-tray in your vehicles passenger seat by setting it on the platform “A” which keeps the drinks level. The sides “E”, the front side “C”, the back side “B”, the platform backside “F”, and base “G” all act as a reservoir to catch and hold any liquid that could spill. The front side “C”, the left side “D”, the right side “D”, and the back side “B” are all raised approximately 1 inch higher than both platforms “A” to keep the drink-tray from sliding off of the platforms “A”. Most seatbelts will set between the front row and back row of drinks in a drink-tray to secure them even more.

It could be made by using thin plastic and cutting each piece individually and using hot-glue to fasten the pieces together. You could use plastic with a mold to make it.

Place the Drink-Tray Holder on the passenger seat of your vehicle before you receive your drink-tray at the fast-food restaurant or convenient store. The front side “C” of the drink-tray holder should be near the front of your seat and the back side “B” should be near or touching the seatback.

There is nothing like it.

### DRAWINGS

FIG. 1 Top, rear, and side view.

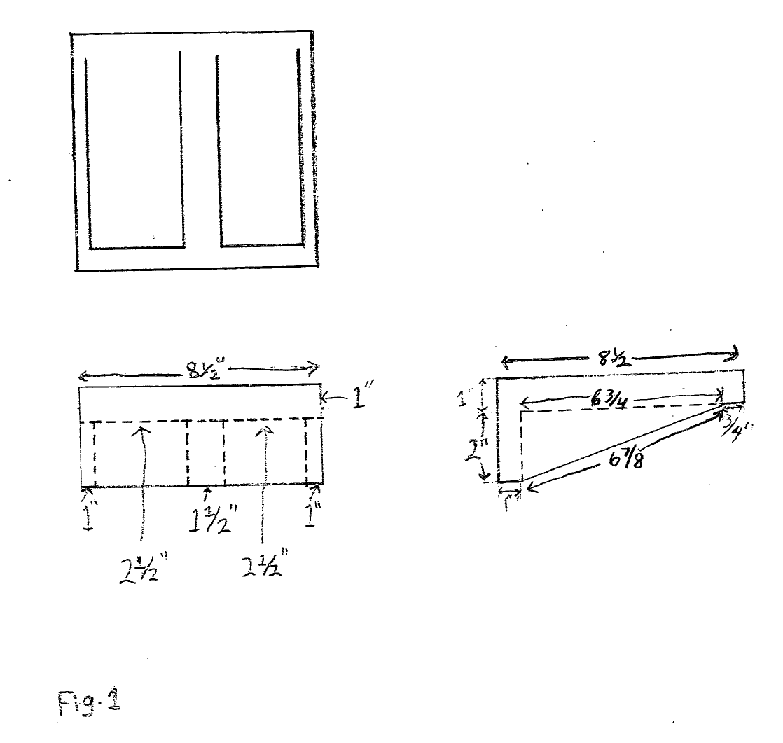

FIG. 2 Cutaway view from slightly above the left rear.

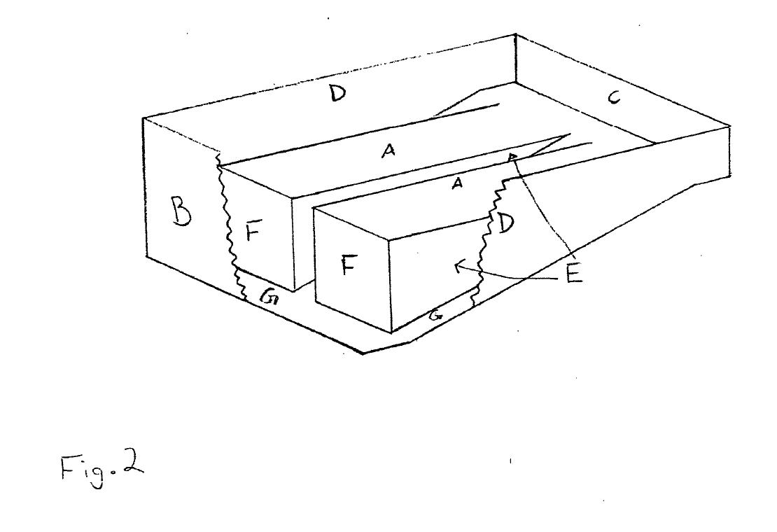

FIG. 3 View from slightly above the right front.

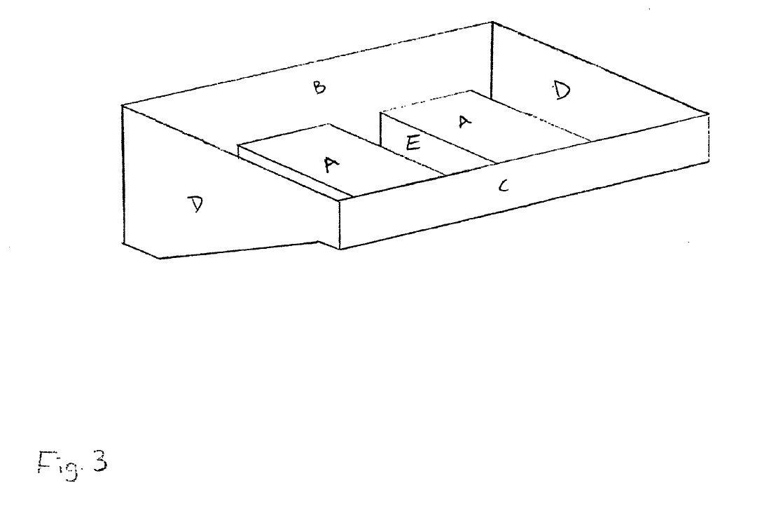

What is claimed is:

1. A drink-tray holder keeps a drink-tray level and secure on the passenger seat of your car.
